(19) United States
(12) Patent Application Publication
(10) Pub. No.: US 2017/0183951 A1
(43) Pub. Date: Jun. 29, 2017

(54) METHOD OF FRACTURING SUBTERRANEAN FORMATION

(71) Applicant: Schlumberger Technology Corporation, Sugar Land, TX (US)

(72) Inventors: Sergei Andreevich Boronin, Moscow (RU); Andrei Alexandrovich Osiptsov, Moscow (RU)

(21) Appl. No.: 15/386,225

(22) Filed: Dec. 21, 2016

(30) Foreign Application Priority Data
Dec. 25, 2015 (RU) 2015155972

(51) Int. Cl. E21B 43/267; C09K 8/62; C09K 8/80

(52) U.S. Cl. CPC E21B 43/267; C09K 8/80; C09K 8/62; C09K 2208/08

(57) ABSTRACT

To create stable conductive channels in propped fractures a first fracturing fluid free of proppant particles is injected into a wellbore and then a second fracturing fluid which is a suspension of proppant particles is injected into the wellbore. The second fluid possesses a yield stress and an aging behavior. A ratio of viscosity of the first fluid to viscosity of the second fluid is not less than 0.1. Then, a third fracturing fluid free of proppant particles is injected into the wellbore, a ratio of the viscosity of the first fluid to viscosity of the third fluid being not less than 0.1, and a ratio of densities of the first and the third fluid being from 0.8 to 1.2. The second fracturing fluid is re-injected into the wellbore, and then the third fracturing fluid is re-injected.

### CROSS-REFERENCE TO RELATED APPLICATION

This application claims priority to Russian Application No. 2015155972 filed Dec. 25, 2015, which is incorporated herein by reference in its entirety.

### BACKGROUND

The disclosure relates to techniques of fracturing of a subterranean oil and gas formation, more particularly, to methods of placing proppant into a fracture.

Hydraulic formation fracturing (HFF) is a basic process for increasing the productivity of a productive formation due to formation of new fractures or widening and deepening natural fractures in the formation. In the initial stage, a fracturing fluid is injected under high pressure into a wellbore which intersects a subterranean formation. Under the high pressure the formation and rock are destructed and fractured. In the next stage, a fluid containing a propping filler (proppant) such as solid particles is injected into the fracture to prevent closing the fracture upon releasing the pressure on the formation which improves extraction of the recovered fluid, i.e. oil, gas or water.

Fracturing fluids are typically aqueous solutions which contain a thickening agent, e.g. soluble polysaccharides, which provide a sufficient fluid viscosity to transport the proppant into the fracture. Examples of thickening agents are polymers such as guar and its derivatives.

There are a number of patent documents relating to the techniques of injecting fluids into a hydraulic fracture to improve the conductivity of produced fractures.

US Publication No. 20050274523 describes a technique of injecting fluids in a hydraulic fracture to create conductive channels and prevent blowing up proppant particles into the well in the process of closing the fracture and extraction of hydrocarbons. The fluids may contain various additives (polymers, proppant particles of different diameters). The invention discloses the range of viscosities of the fluids, which ensures optimum conditions for creating conductive channels.

US Publication No. 20120305247 describes a method for injecting fluids into a hydraulic fracture using a suspension containing a high volume percent of particles. The particles are of at least two types which differ in size. Injection of the suspension is alternated with injection of a viscous fluid free of particles, which creates proppant-free channels. Options for the suspension composition are disclosed with the addition of thickening agents, dissolved gas, decomposing materials and fibers.

US Publication No. 2015083420 discloses a method for hydraulic fracturing of a hydrocarbon formation, which relies on injecting a fluid into a hydraulic fracture in stages. In some stages a proppant can be added to the fluid. As a result vertically extending pillars are created, which are filled with one of the fluids, and have conductive channels between them. Possible compositions and rheology of the fluids are disclosed (they may be viscoelastic, comprise crosslinking polymer, or a mixture of different particles of proppant, etc.).

The disadvantage of these methods is that the conductive channels created in the process of injecting into the hydraulic fracture are not stable and can join in the process of closing the fracture because of gravitational deposition of particles, gravitational slipping of the suspension areas containing particles, and the suspension flow caused by the reflux through perforations.

### SUMMARY

The disclosure provides creation of stable conductive channels in propped fractures by reducing gravitational settling of the proppant and preventing gravitational slipping of the suspension and closing of open channels between the proppant-filled areas in the stages of injection and closing. Creation of the conductive channels increases in turn extraction of hydrocarbons and other formation fluids.

The disclosed method comprises injecting a first fracturing fluid free of proppant particles into a wellbore. Then a second fracturing fluid comprising a suspension of proppant particles is injected into the wellbore, the second fluid possesses a yield stress and an aging behavior. A ratio of viscosity of the first fluid to viscosity of the second fluid is not less than 0.1. Then, a third fracturing fluid free of proppant particles is injected into the wellbore, a ratio of the viscosity of the first fluid to viscosity of the third fluid is not less than 0.1, and a ratio of densities of the first and the third fluid is from 0.8 to 1.2. The second fracturing fluid is re-injected into the wellbore, and then the third fracturing fluid is re-injected.

In accordance with an embodiment of the disclosure, the first and the third fracturing fluid may be the same fluid.

In accordance with embodiments of the disclosure, the yield stress of the second fracturing fluid can be provided by a high concentration of the proppant particles in the suspension, by the use of a cross-linked gel as the second fracturing fluid, or by adding special fibers to the second fracturing fluid.

In accordance with one or more embodiments the sequential injection into the wellbore of the second fracturing fluid, the third fracturing fluid and re-injection of the second and the third fracturing fluids are cyclically repeated.

In accordance with another embodiment after the re-injection of the third fracturing fluid the first and the second fracturing fluids are additionally injected into the wellbore.

### BRIEF DESCRIPTION OF DRAWINGS

The disclosure is illustrated by the drawings wherein:

FIG. 1 shows a distribution of the fluids in the hydraulic fracture upon completion of the stage of re-injection of the third fracturing fluid with a yield stress of 10 Pa in the absence of aging of the suspension;

FIG. 2 shows a distribution of the fluids in the hydraulic fracture upon completion of the stage of re-injection of the third fracturing fluid with a yield stress of 10 PA with aging of the suspension;

FIG. 3 shows a distribution of the fluids in the hydraulic fracture upon completion of the stage of re-injection of the third fracturing fluid with a yield stress of 40 Pa in the absence of aging of the suspension; and

FIG. 4 shows distribution of the fluids in the hydraulic fracture upon completion of the stage of re-injection of the third fracturing fluid with a yield stress of 60 Pa in the absence of aging of the suspension.

### DETAILED DESCRIPTION

The present method is based on yield and aging properties of a fracturing fluid saturated with particles. The method provides a system for supplying fluids and a sequence of injecting the fluids to create proppant areas separated by conductive channels in the propped fracture due to displacement of the suspension with the fluid and assisted by aging of the suspension.

Supplying at least two fracturing fluids and a sequence of injecting the at least two fracturing fluids into the fracture are aimed at creating separate areas occupied by a proppant along the fracture due to the development of instability at an interface between the fracturing fluids. The system for supplying fluids and the sequence of injection ensure the creation of highly conductive channels in the suspension containing particles of proppant. After closing the fracture the channels will serve as conductive channels for the flow of hydrocarbons (or other formation fluids) from the formation into the wellbore, increasing thereby the flow rate and extraction of the fluids.

The process of placing the fluids involves multiple stages and at least two different fracturing fluids.

In a first stage, a first, clean viscous fracturing fluid free of proppant particles (a viscous “pad” for opening a fracture and creating conductive channels in a suspension containing particles) is injected into a wellbore. The proppant-free “pad”, injected in this stage, creates a hydraulic fracture in the subterranean formation and forms flow channels for other fluids upon closing the fracture. An example of the fluid used in this stage may be water or aqueous solution of a polymer (for example, cross-linked YF gel or linear WF gel).

In a second stage, a second fracturing fluid, a suspension containing proppant particles, is injected. To reduce gravitational slipping of the suspension a ratio of viscosity of the “pad”, i.e. the first fracturing fluid, to viscosity of the second fracturing fluid is higher than 0.1, in a range from 0.1 to 0.9. In this context “viscosity” refers to the dynamic viscosity of Newtonian fluids or apparent viscosity calculated on the basis of the average shear rate, which, in turn, is the ratio of an average velocity of injection to a half thickness of the hydraulic fracture.

Rheological properties and composition of the second fracturing fluid, injected in the second stage, meets the following requirements: the second fracturing fluid has a yield stress, which means that at low shear stress the fluid behaves as a solid, and has an aging behavior which means the yield stress increases with time.

An example of a fluid having a yield stress may be an aqueous solution of a polymer having strong intermolecular bonds (cross linked gel YF 100-150).

The yield stress of the second fracturing fluid can also be provided by a high concentration of the proppant particles in the suspension (the volume fraction of particles in the range of 0.4-0.55) or by adding special fibers to the fluid (for example, LT1 fibers with a length from 0.5 to 2 cm, a diameter from 0.01 mm to 0.02 mm and a density from 1.4 to 2.7 g/cm³). The aging of the second fluid in conditions of hydraulic fracturing may be provided by the use of special chemicals and proppant particles (e.g. cross linked gel YF 100-150, in which the number of intermolecular bonds increases with time, thereby increasing the yield stress of the fluid as a whole). The suspension having the above rheological properties and composition ensures transport of proppant particles into the depth of the fracture, prevents gravitational slipping of the areas occupied by the proppant, and settling of the proppant.

In the third stage of the method, a third fracturing fluid is injected into the wellbore. This fluid is a viscous fluid, which may be the same fluid as the “pad” in the first stage. The viscous fluid injected in this stage has a viscosity less than the viscosity of the suspension injected in the second stage: the ratio of the viscosity of the third fluid to the viscosity of the second fracturing fluid is above 0.1. Injection of the fluid in the third stage causes the development of the Saffman-Taylor instability at an interface with the second fluid and the formation of open channels in the second fluid.

Fourth and fifth stages are used to ensure a uniform placement of proppant areas separated by conductive channels of the clean fluid along the fracture, which is facilitated by the aging of the suspension.

The fourth stage involves re-injection of the second fracturing fluid with the proppant particles into the wellbore. Injection of the suspension with the proppant particles in a single step usually causes a decrease in the propped length or the open area near the well, which significantly reduces the overall conductivity of the fracture.

The fifth stage involves repeated injection of the third fracturing fluid, that is, the same viscous fluid as in the third stage.

Duration of the stages may be, for example, the following: at injection with a flow rate of 7 barrels per minute, the first stage may be a half hour to hour, the second stage may be 7.5 minutes, the third stage 4.5 minutes, the fourth stage 7.5 min, and the fifth stage 15.5 min.

In some cases, the fifth stage can be the longest in time compared to the other stages in order to create channels in the suspension with the proppant particles throughout the length of the hydraulic fracture.

Density of the first and third fluids injected at the first, the third and the fifth stages is approximately the same to reduce the gravitational slipping (the ratio of densities is in the range of 0.8 to 1.2) (this density range covers many combinations of fluids).

The above second to fifth stages can be repeated cyclically.

After re-injection of the third fracturing fluid at the fifth stage an additional injection into the wellbore of the first and the second fracturing fluids can be effected (for a more uniform distribution of the suspension in the fracture).

The following examples, which demonstrate on the basis of numerical simulation using a software code how different the results can be that are provided by the above-described system for supplying fluids and the sequence of injection in field environments.

Consider an open fracture with dimensions of 70×70×0.006 m (height×length×thickness), where the volumetric flow rate in all injection stages is assumed to be 0.02 m³/s. The injection involves a clean fluid with power-law rheology and a viscoplastic suspension (having a yield stress). Density and rheology characteristics of fluids discussed in Examples 1-4 are shown in Table 1:

TABLE 1

| | | Density, | | Power viscosity law |
|---|---|---|---|---|
| No. | Fluid | kg/cu m | Consistence, cPs | exponent |
| 1 | Clean fluid | 1000 | 2.0 | 0.6 |
| 2 | Suspension | 2000 | 1.63 | 0.83 |

In the following examples, duration of injection stages, yield stress of the suspension and its dependence on time (solidification) are varied.

### EXAMPLE 1

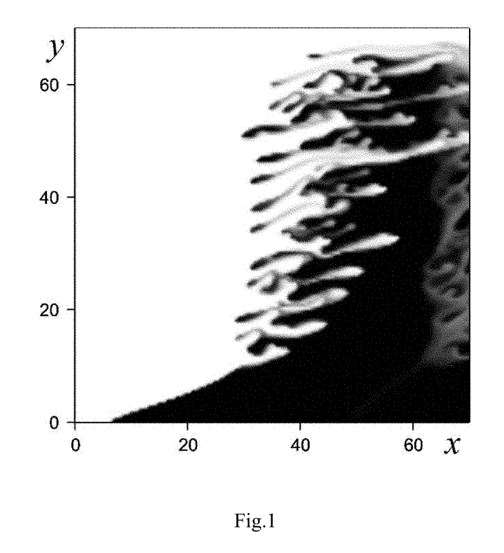

In this example, the sequence of injection, at which the yield stress of the suspension is assumed to be 10 Pa, no solidification of the suspension occurs (the yield stress of the suspension is constant). Table 2 shows the schedule of injection into the formation, and FIG. 1 shows the distribution of fluids in the fracture after the injection according to the schedule presented in Table 2 upon completion of the fifth stage according to the simulation using a program code. A black color in FIG. 1 corresponds to the suspension, and s white color to clean fluid.

TABLE 2

| No. | Duration of injection, min | Fluid |
|---|---|---|
| 1 | Initial filling of fracture | Clean fluid |
| 2 | 7.5 | Suspension |
| 3 | 4.5 | Clean fluid |
| 4 | 7.5 | Suspension |
| 5 | 15.5 | Clean fluid |

Fluids are injected from the left vertical boundary of the flow region. Initially, the fracture is filled with a clean fluid. As a sand carrier fluid (suspension with proppant particles) enters the flow region it undergoes strong gravitational slip effects. Fingers of the clean fluid are formed at the interface with the sand carrier fluid, and most of these fingers do not penetrate into the sand carrier. Instability at the interface is weakened by gravitational slipping. In addition, the sand carrier is squeezed deeply into the fracture, leaving a large un-propped area near the mouth, therefore the placement can be considered unsuccessful.

### EXAMPLE 2

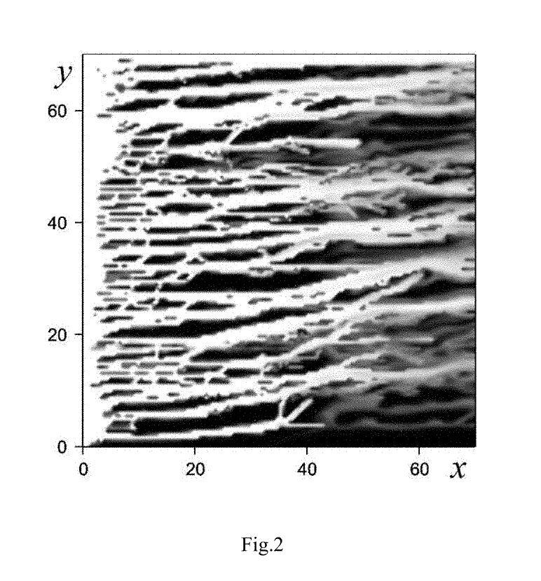

This example demonstrates the effect of solidification of the suspension on placing the fluid under the same injection conditions as in Example 1. The same sequence of injection is used, but here the yield stress of the suspension is increased over time proportionally to \sqrt{t}, where t is the time interval from the beginning of injection. Initial yield stress of the suspension is assumed to be 10 Pa as in Example 1. FIG. 2 shows the distribution of fluids in the hydraulic fracture after the injection according to the schedule presented in Table 2. The suspension solidifies with the initial yield stress being 10 Pa. A black color corresponds to the suspension and a white color to the clean fluid. As compared to the distribution obtained in Example 1, the suspension is uniformly distributed in the fracture; there are also channels of clean fluid, which penetrate the suspension and create conductive channels in the fracture. Solidification of the suspension lowers its gravitational slipping and contributes to uniform placement of proppant throughout the fracture.

### EXAMPLE 3

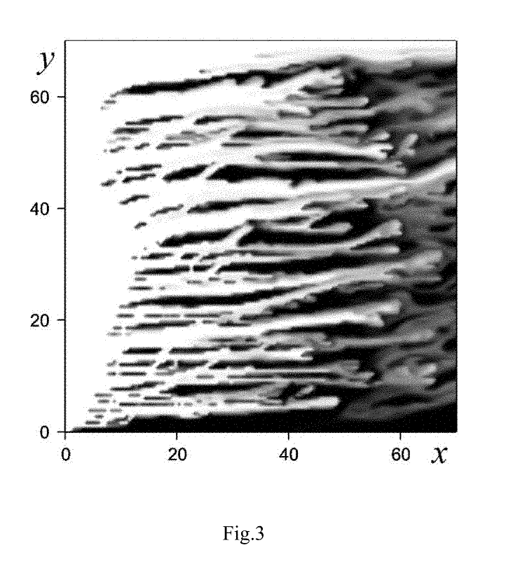

This example demonstrates the effect of yield stress on placement of fluids in the absence of solidification of the suspension. Yield stress of the suspension is assumed to be 40 Pa, which is close to the average yield stress at the time of injection of the solidifying suspension considered in Example 2. The sequence of injection is similar to that described in Examples 1 and 2. FIG. 3 shows the distribution of fluids in the hydraulic fracture after injection according to the schedule presented in Table 2. Yield stress of the suspension is fixed at 40 Pa. A black color corresponds to the suspension and a white color to the clean fluid.

Analysis of distribution of the fluids upon completion of injection in the appropriate sequence, as shown in FIG. 3, indicates that an increase in the yield stress of the suspension in the absence of solidification will not provide the desired uniform distribution of the proppant in the fracture. The suspension has a higher number of channels compared to the distribution obtained in Example 1, however, there is a clean region near the mouth, the width of which is substantially greater than in Example 2, in which solidification of the suspension is considered. There is also a layer of clean fluid at the top of the fracture, which is formed due to gravitational slipping of the sand carrier fluid. Both these factors will significantly reduce conductivity of the fracture after its closure in comparison with the injection shown in Example 2.

### EXAMPLE 4

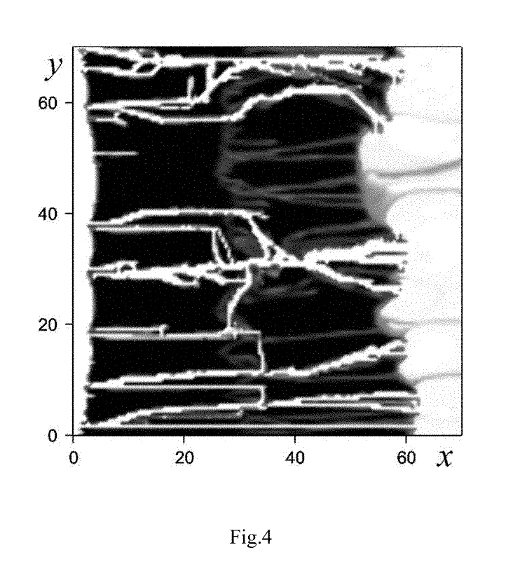

This example presents the effect of yield stress of the suspension on placement of the proppant in a hydraulic fracture. Flow conditions are similar to those in Examples 1 and 3, but here the yield stress of the suspension is assumed to be 60 Pa, which is close to the highest yield stress of the solidifying suspension attained in Example 2. FIG. 4 shows the distribution of fluids in the hydraulic fracture after injection according to the schedule presented in Table 2. Yield stress of the suspension is fixed and equal to 60 Pa. A black color corresponds to the suspension and a white color to clean fluid.

As shown in FIG. 4, a further increase in the yield stress compared to the injection in Example 3 led to a decrease in the propped fracture length: the suspension became non-flowing once the channels of the pure fluid were formed, and movement on the fracture slowed significantly compared to the other discussed examples. Another disadvantage of using the suspension with a high yield stress is that the clean fluid channels tend to unite, therefore, the total number of conductive channels is considerably smaller compared to the injection discussed in Examples 2, 3. Reduction in the propped length and the number of channels will reduce conductivity of the fracture in comparison with the fluid supply system considered in Example 2.

The described system for supplying fluids and the sequence of fluid injections ensure the creation of viscous fluid channels in the suspension containing proppant particles. The fluidity and solidification properties of the suspension reduce gravitational settling of the proppant and agglomeration of areas occupied by the proppant in the stages of injection and closing the hydraulic fracture. Fluidity and solidification properties of the suspension are important for uniform placement of the suspension along the fracture length, and also for preventing gravitational slipping of the suspension and closure of open channels between the proppant-filled areas. The latter is particularly important in the last stages of hydraulic fracturing when the injection is terminated and the fracture is closed.

1. A method for fracturing a subterranean formation, comprising:
injecting into a wellbore a first fracturing fluid free of proppant particles,
injecting into the wellbore a second fracturing fluid, wherein the second fracturing fluid is a suspension of proppant particles having a yield stress and an aging behavior, and wherein a ratio of viscosity of the first fracturing fluid to a viscosity of the second fracturing fluid is not less than 0.1;
injecting into the wellbore a third fracturing fluid free of proppant particles, wherein a ratio of viscosity of the third fracturing fluid to the viscosity of the second fracturing fluid is not less than 0.1, and a ratio of densities for the first fracturing fluid and the third fracturing fluid is from 0.8 to 1.2;
re-injecting into the wellbore the second fracturing fluid; and
re-injecting into the wellbore the third fracturing fluid.

2. The method of claim 1, wherein the first and the third fracturing fluid are the same fluid.

3. The method of claim 1, wherein the yield stress of the second fracturing fluid is provided by a high concentration of the proppant particles in the suspension.

4. The method of claim 1, wherein the yield stress of the second fracturing fluid is provided by the use of a cross-linked gel.

5. The method of claim 1, wherein the yield stress of the second fracturing fluid is provided by adding fibers.

6. The method of claim 1, wherein the sequential injection into the wellbore of the second fracturing fluid, the third fracturing fluid and re-injection of the second and the third fracturing fluids are cyclically repeated.

7. The method of claim 1, wherein after re-injection of the third fracturing fluid an additional injection into the wellbore of the first and the second fracturing fluids is carried out.

8. The method of claim 1, wherein a duration of the re-injection of the third fracturing fluid is longer than a duration of the injection of the first and second fluids.
